(19) United States
(12) Patent Application Publication
(10) Pub. No.: US 2015/0018450 A1
(43) Pub. Date: Jan. 15, 2015

(54) TIRE SEALER AND INFLATOR AND ASSOCIATED METHODS OF PACKAGING

(71) Applicant: TECHNICAL CHEMICAL COMPANY, Cleburne, TX (US)

(72) Inventor: N. Howard DUDLEY, Blum, TX (US)

(21) Appl. No.: 13/939,769

(22) Filed: Jul. 11, 2013

(51) Int. Cl. B29C 73/16; B65B 3/04

(52) U.S. Cl. CPC B29C 73/163; B65B 3/04
USPC 523/166; 53/474

(57) ABSTRACT

A tire sealer and inflator can include a sealant composition, and a propellant composition. The propellant composition can include R152a (1,1-difluoroethane) propellant. The sealant composition and the propellant composition may be combined in an aerosol container. The aerosol container can be a DOT 2Q container.

### BACKGROUND

This disclosure relates generally to compositions for use in aerosol containers and, in an example described below, more particularly provides a tire sealer and inflator, and associated methods of packaging.

Tire sealers and inflators are used to, at least temporarily, seal leaks (such as punctures) in tires, and to inflate the sealed tires. A tire inflated using a tire sealer and inflator should be pressurized sufficiently to allow driving on the tire until the tire can be transported to a suitable repair facility.

Therefore, it will be appreciated that improvements are continually needed in the art of producing tire sealers and inflators which will perform their intended functions satisfactorily, while permitting the tire sealers and inflators to be safely, economically and conveniently produced, packaged, distributed and used.

### DETAILED DESCRIPTION

The present inventors have invented a new tire sealer and inflator which is demonstrated by the following example:

### Example

A tire sealer and inflator was prepared as follows, by weight:

| | |
|---|---|
| Water (H₂O) | 48.380% |
| Monoethanolamine Borate (C₂H₁₀BNO₄) | 0.240% |
| Ammonium Hydroxide (NH₄OH) | 0.139% |
| Monoethanolamine (C₂H₇NO) | 0.650% |
| Ethanol (C₂H₆O) | 3.250% |
| Isopropyl Alcohol (C₃H₈O) | 1.890% |
| Latex (C₃H₃N) | 15.370% |
| R134a (1,1,1,2-tetrafluoroethane) | 27.070% |
| R152a (1,1-difluoroethane) | 3.010% |

The tire sealer and inflator was placed in a 12 oz. (approx. 29.57 ml) aerosol can. The total weight of the tire sealer and inflator placed in the can was 12 oz.

The aerosol can was of the type known to those skilled in the art as a DOT (United States Department of Transportation) 2Q aerosol can. Such aerosol cans are much more widely available and less expensive than, for example, DOT E aerosol cans. DOT 2Q cans are rated for use where internal pressure will not exceed about 190 psig (approx. 12.4 bar) at 130 deg. F (approx. 54.4 deg. C).

With the above example tire sealer and inflator placed in a DOT 2Q can, the can (and tire sealer and inflator therein) were heated to 131 deg. F (approx. 55 deg. C) by immersion in a hot water bath, and pressure inside the can was measured using a calibrated pressure gauge modified with an adaptor to fit a valve stem of the aerosol can. Several tests were performed, and the measured pressure was in the range of 180-190 deg. F (approx. 12.4-13.1 bar).

The vapor pressure of the tire sealer and inflator in the DOT 2Q aerosol can is sufficient to acceptably inflate a normal passenger car tire, and allow the tire to be driven on. It was, thus, determined that a novel tire sealer and inflator could be packaged in a DOT 2Q aerosol can, with a propellant composition of the tire sealer and inflator having the following blend of propellants, by weight:

| | |
|---|---|
| R134a (1,1,1,2-tetrafluoroethane) | 90% |
| R152a (1,1-difluoroethane) | 10% |

Note that the R152a propellant has a lower vapor pressure than the R134a propellant, but is miscible with R134a to thereby form an azeotrope.

Preferably, the propellant composition would include less than 12% of the R152a. That is, the propellant composition having a maximum amount of R152a would be prepared as follows, by weight:

| | |
|---|---|
| R134a (1,1,1,2-tetrafluoroethane) | >88% |
| R152a (1,1-difluoroethane) | <12% |

A preferred propellant composition would be prepared as follows, by weight:

| | |
|---|---|
| R134a (1,1,1,2-tetrafluoroethane) | 89-99% |
| R152a (1,1-difluoroethane) | 1.0-11% |

A preferred sealant composition would be prepared as follows, by weight:

| | |
|---|---|
| Water (H₂O) | 65-75% |
| Monoethanolamine Borate (C₂H₁₀BNO₄) | 0.25-1.0% |
| Ammonium Hydroxide (NH₄OH) | 0.10-0.50% |
| Monoethanolamine (C₂H₇NO) | 0.75-1.25% |
| Ethanol (C₂H₆O) | 4.0-5.0% |
| Isopropyl Alcohol (C₃H₈O) | 2.5-3.5% |
| Latex (C₃H₃N) | 20-30% |

A pH of the sealant composition would preferably be at least 9.4.

The ammonium hydroxide and monoethanolamines are used as corrosion inhibitors, but other suitable corrosion inhibitors include (but are not limited to) sodium nitrite, morpholine and alkanolamine. Preferably, all corrosion inhibitors make up less than 2% of the sealant composition.

The ethanol and isopropyl alcohol are freezing point depressants. Other suitable freezing point depressants include (but are not limited to) alcohols and/or salts of acetic acid, methanol, potassium acetate and sodium acetate.

The latex is a sealer for sealing a tire puncture or other leak. Other suitable sealants include (but are not limited to) acrylic resin emulsion, vinyl acetate and polyvinyl acetate emulsion.

The tire sealer and inflator would preferably comprise a blend of the propellant composition and the sealant composition as follows, by weight:

| | |
|---|---|
| propellant composition | 25-33% |
| sealant composition | 67-75% |

It may now be fully appreciated that the tire sealer and inflator described above provides significant advancements to the art. The tire sealer and inflator can be safely, economically and conveniently produced, packaged, distributed and used. For example, the tire sealer and inflator can be packaged in a DOT 2Q aerosol can (if desired) due, at least in part, to the presence of the R152a propellant.

An improved tire sealer and inflator is provided to the art by the above disclosure. In one example the tire sealer and inflator can comprise a sealant composition and a propellant composition. The propellant composition includes R152a (1,1-difluoroethane) propellant.

The propellant composition can also include R134a (1,1,1,2-tetrafluoroethane) propellant. The propellant composition may include greater than 88% by weight of the R134a (1,1,1,2-tetrafluoroethane) propellant.

The propellant composition may include approximately 90% by weight of the R134a (1,1,1,2-tetrafluoroethane) propellant, and approximately 10% by weight of the R152a (1,1-difluoroethane) propellant.

The propellant composition may include less than 12% by weight of the R152a (1,1-difluoroethane) propellant. The propellant composition may include approximately 1.0-11% by weight of the R152a (1,1-difluoroethane) propellant. The propellant composition may include approximately 89-99% by weight of R134a (1,1,1,2-tetrafluoroethane) propellant.

The sealant composition can include a vinyl sealer. The propellant composition and the sealant composition may be combined in a DOT 2Q aerosol container (although other types of containers may be used, if desired). The sealant composition can comprise a corrosion inhibitor.

A method of packaging a tire sealer and inflator is also described above. In one example, the method can comprise combining a sealant composition and a propellant composition in an aerosol container, with the propellant composition including R152a (1,1-difluoroethane) propellant.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples.

One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the examples are described merely as useful applications of the principles of this disclosure, which is not limited to any specific details of these examples.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. Accordingly, the foregoing detailed description is to be clearly understood as being given by way of illustration and example only, the spirit and scope of the invention being limited solely by the appended claims and their equivalents.

What is claimed is:

1. A tire sealer and inflator, comprising:
a sealant composition; and
a propellant composition,
wherein the propellant composition includes R152a (1,1-difluoroethane) propellant.

2. The tire sealer and inflator of claim 1, wherein the propellant composition further includes R134a (1,1,1,2-tetrafluoroethane) propellant.

3. The tire sealer and inflator of claim 2, wherein the propellant composition comprises greater than 88% by weight of the R134a (1,1,1,2-tetrafluoroethane) propellant.

4. The tire sealer and inflator of claim 2, wherein the propellant composition comprises approximately 90% by weight of the R134a (1,1,1,2-tetrafluoroethane) propellant, and approximately 10% by weight of the R152a (1,1-difluoroethane) propellant.

5. The tire sealer and inflator of claim 1, wherein the propellant composition comprises less than 12% by weight of the R152a (1,1-difluoroethane) propellant.

6. The tire sealer and inflator of claim 1, wherein the propellant composition comprises approximately 1.0-11% by weight of the R152a (1,1-difluoroethane) propellant.

7. The tire sealer and inflator of claim 6, wherein the propellant composition comprises approximately 89-99% by weight of R134a (1,1,1,2-tetrafluoroethane) propellant.

8. The tire sealer and inflator of claim 1, wherein the sealant composition includes a vinyl sealer.

9. The tire sealer and inflator of claim 1, wherein the propellant composition and the sealant composition are combined in a DOT 2Q aerosol container.

10. The tire sealer and inflator of claim 1, wherein the sealant composition comprises a corrosion inhibitor.

11. A method of packaging a tire sealer and inflator, the method comprising:
combining a sealant composition and a propellant composition in an aerosol container,
wherein the propellant composition includes R152a (1,1-difluoroethane) propellant.

12. The method of claim 11, wherein the propellant composition further includes R134a (1,1,1,2-tetrafluoroethane) propellant.

13. The method of claim 12, wherein the propellant composition comprises greater than 88% by weight of the R134a (1,1,1,2-tetrafluoroethane) propellant.

14. The method of claim 12, wherein the propellant composition comprises approximately 90% by weight of the R134a (1,1,1,2-tetrafluoroethane) propellant, and approximately 10% by weight of the R152a (1,1-difluoroethane) propellant.

15. The method of claim 11, wherein the propellant composition comprises less than 12% by weight of the R152a (1,1-difluoroethane) propellant.

16. The method of claim 11, wherein the propellant composition comprises approximately 1.0-11% by weight of the R152a (1,1-difluoroethane) propellant.

17. The method of claim 16, wherein the propellant composition comprises approximately 89-99% by weight of R134a (1,1,1,2-tetrafluoroethane) propellant.

18. The method of claim 11, wherein the sealant composition includes a vinyl sealer.

19. The method of claim 11, wherein the combining further comprises combining the propellant composition and the sealant composition in a DOT 2Q aerosol container.

20. The method of claim 11, wherein the sealant composition comprises a corrosion inhibitor.
